(19) United States
(12) Patent Application Publication
(10) Pub. No.: US 2006/0164553 A1
(43) Pub. Date: Jul. 27, 2006

(54) Composite three-dimensional scene and set for and method of creating same

(76) Inventor: Ben Tyberg, Brooklyn, NY (US)

Correspondence Address: MIRICK, O'CONNELL, DEMALLIE & LOUGEE, 100 FRONT STREET, WORCESTER, MA, 01608, US

(21) Appl. No.: 11/314,188

(22) Filed: Dec. 22, 2005

Related U.S. Application Data
(60) Provisional application No. 60/639,738, filed on Dec. 28, 2004.

(51) Int. Cl. H04N 9/74

(52) U.S. Cl. 348/586

(57) ABSTRACT

A set and method of using the set, for use in creating a three-dimensional decoupage scene defined by a background scene, and a multi-piece foreground scene having depth relative to the background scene. There is a background substrate carrying graphics that visually create a particular scene, and a plurality of foreground pieces each carrying on a front face graphics that are visually identical to a portion of the background scene, and each having a back face. Standoff members are used to separate the foreground pieces from an underlying foreground piece or the background. There are printed indicia conveying to the user an indication of one or more locations on the back face of at least one foreground piece for placement of one or more standoffs, to hold foreground pieces a particular distance off of other foreground pieces and/or the background substrate, to create depth in the scene comprising the background scene and the foreground scene made up from the plurality of foreground pieces.

### CROSS REFERENCE TO RELATED APPLICATION

This application claims priority of provisional application Ser. No. 60/639,738, filed on Dec. 28, 2004.

### FIELD OF THE INVENTION

This invention relates to a composite three-dimensional scene and method of creating such a scene.

### BACKGROUND OF THE INVENTION

Craft projects have become a popular pastime. Children and adults enjoy creating interesting and attractive framed scenes that can be hung on a wall or stood up on a tabletop. Adding three-dimensionality to a scene heightens the interest, and is thus desirable. However, making a three-dimensional decoupage-like scene, or a shadow box-like scene is time consuming, and thus can be daunting to both children and adults. It is therefore desirable to make the assembly of a three-dimensional scene relatively easy.

### SUMMARY OF THE INVENTION

It is therefore an object of this invention to provide a kit for a user to create a three-dimensional scene, and the method by which the kit is used to create the scene, and the resulting scene. The invention herein may be accomplished in a composite three-dimensional scene and method of creating such a scene. More specifically, a set of materials for creating a three-dimensional decoupage scene, the scene created by this set, the method of designing the set, the method of creating the set, and the method of assembling the set into the decoupage scene. The assembled decoupage scene comprises a printed background scene and one or more overlying foreground scene portions that are each held a particular distance off of the background scene to create depth in the assembled product.

The background substrate may define a border area outside of the graphics that folds relative to the graphics. The background substrate can be scored to define a fold line between the graphics and the border area. The border area may fold to be generally perpendicular to the graphics. The set may further comprise a frame having sides with depth, in which the folded border area lies proximate the frame sides.

The printed indicia may also convey to the user the quantity of standoff members for each location on the back face of the foreground pieces. The printed indicia may include a number indicative of the quantity of standoff members to be placed at that location. The standoff members may have predefined shapes and sizes. The printed indicia may comprise borders that match the standoff shape. The printed indicia borders may match the standoff size and shape, and may also convey to the user the quantity of standoff members for each location on the back face of the foreground pieces.

At least two foreground pieces may be identical and located one directly on top of another. The standoff members located between two identical foreground pieces preferably keep the pieces completely separated. The two identical foreground pieces may be essentially parallel to one another. The standoff members may have adhesive on their front and back protected by a peel-off member. The standoff members may be part of a sheet of material that is precut such that each member is separable from the sheet. The standoff members may all be the same shape and size, which may be essentially rectangular. At least one standoff member may comprise two separate adhesive portions joined by an elongated member, to increase the thickness of the standoff.

Also featured is a set for use in creating a decoupage scene that is defined by a background scene and a multi-piece foreground scene that has depth relative to the background scene. The set comprises a background substrate carrying graphics that visually create a particular background scene. There are a plurality of foreground pieces, each piece carrying on a front face graphics that are identical to a portion of the background scene. Each foreground piece visually creates a portion of the foreground scene. The set further comprises some means of creating standoffs that physically separate one or more of the foreground pieces from the background substrate and/or one from another. The set further comprises printed indicia conveying to the user an indication of one or more locations on the back face of one or more of the foreground pieces for placement of one or more of such standoffs.

### BRIEF DESCRIPTION OF THE DRAWINGS

Other objects, features and advantages will occur to those skilled in the art from the following description of the preferred embodiments and the accompanying drawings, in which:

FIG. 1 is a schematic front view of an assembled three-dimensional scene decoupage set designed, constructed, and assembled according to the invention;

FIG. 2 is a cross-sectional view taken along line 2-2 of FIG. 1;

FIG. 3A is an enlarged front view of one of the foreground pieces of FIG. 1, and FIG. 3B is the back view thereof; and

FIG. 4 is a view depicting an alternative means of accomplishing a thicker standoff than shown in FIG. 2.

### DETAILED DESCRIPTION OF THE PREFERRED EMBODIMENTS

Three-dimensional scene decoupage kit 10 comprises background substrate 12 carrying graphics that visually create a particular background scene. In this extremely simplified example, the scene is of a generally oval shape 31 surrounded by an unprinted portion 32. It should be understood that in all likelihood no product would be this simple. Rather, such simple graphics are meant to more clearly convey the invention. In a typical instance, the background scene might be a high-quality landscape or portrait or still life scene.

In the example depicted in the drawings, background substrate 12 is printed on its front face with a color or texture bounded by the dashed line 31. In one embodiment, the set is designed to be assembled into a picture frame. In this case, such assembly may be accomplished by adapting (e.g. by scoring the substrate card stock material) substrate 12 to be folded around its perimeter to create a transversely-projecting perimeter portion 12a that can be accepted by frame 20. Framing can be accomplished in other manners such as by making the background substrate a part of a one-piece frame, or printing a flat substrate that can be glued to a frame, or other like manners.

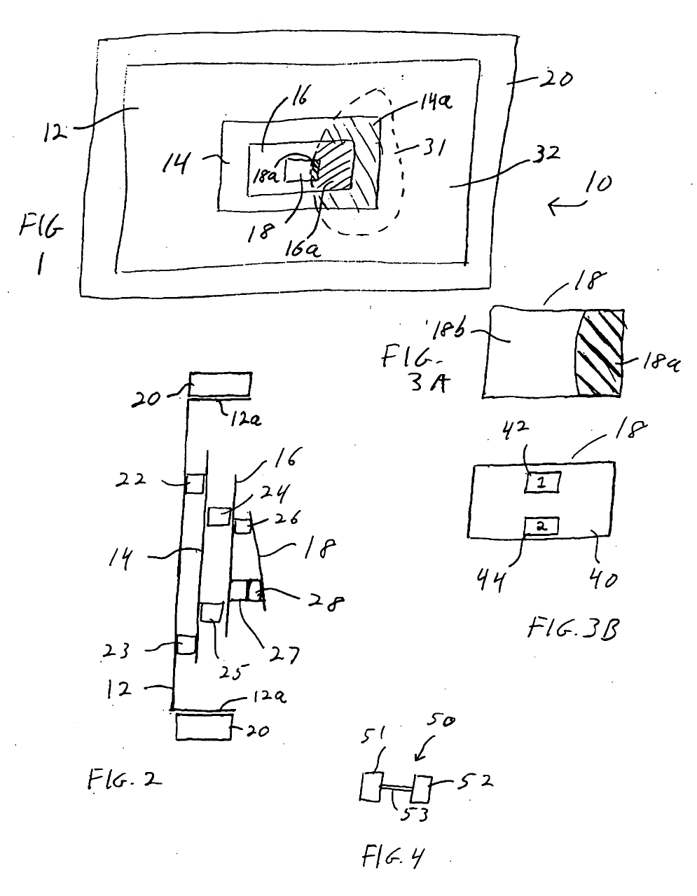

Decoupage set 10 also includes foreground pieces 14, 16 and 18 that are assembled as shown in FIGS. 1 and 2. Each of these foreground pieces carries on its front face graphics that are visually identical to a portion of the foreground scene. In this example, piece 14 overlays a portion of background substrate 12, piece 16 overlays a portion of piece 14, and piece 18 overlays a portion of piece 16. This arrangement is not a limitation of this invention. For example, more commonly the foremost foreground pieces might partially overlap more than one other underlying foreground piece, and at least some of the foreground pieces would also overlap a portion of the background substrate. This arrangement allows the creation of multi-piece scenes having desired depth profiles to create a desired visual appearance of the assembled set. Thus, the selection of the size, shape, printing on, placement, and overlying nature and standoff height of each of the foreground pieces is an important aspect of the invention that substantially affects the visual appearance of the assembled set.

Going back to the example depicted in FIGS. 1-3, first foreground piece 14 is printed in hatched area 14a with a print that is identical to the print of the underlying background substrate region 31. Similarly, second foreground piece 16 is printed in area 16a in the same manner as the printing in printed region 31 of background substrate 12 and printed region 14a of underlying foreground piece 14. Finally, in a similar manner, top foreground piece 18 is printed in portion 18a that overlies portions 16a, 14a, and 31. Thus, these pieces, when properly aligned and overlayed, create visual depth to this portion of the scene.

Another aspect of the invention is one or more standoff members that comprise, or are configurable into, one or more standoffs that hold the foreground pieces off of the underlying substrate. These standoffs can be accomplished in a number of fashions. In one example, the standoffs can be accomplished by providing as part of the set a sheet of foam plastic or other lightweight material having an adhesive on the front and back surfaces protected by a peel-off member. This sheet can be die cut into desired sizes and shapes that then can be separated from the sheet by the user to be adhered to the backs of the foreground pieces as necessary. An advantage of this methodology would be that sheets of uniform size and shape standoffs could be quickly and easily created, or, particular standoff shapes could be easily created.

The invention also comprises printed indicia that convey to the user the locations of (and preferably the quantity of) the standoffs that are used in assembling the set into the finished product. The invention also preferably comprises printed indicia describing to the user the order of placement of the different foreground pieces, which may be accomplished by numbering the foreground pieces sequentially (e.g. “1”, “2”, “3”, etc.). The numbering can be on the backs of the pieces. Alternatively, the numbering could be on printed sheets that also carry foreground pieces, in which the pieces can be torn out of the sheet, with the numerical printing at locations right next to the pieces. Another alternative is another type of printed guide for the user (for example an instruction manual with drawings or other depictions of each foreground piece). This ordering can be indicated overall for the entire set and/or for the order of foreground pieces that stack one upon another.

Regarding the preferred standoffs and an example of their usage, in the simplified example shown in FIGS. 1 and 2, two standoffs 22 and 23 are placed between background substrate 12 and first foreground piece 14, and two standoffs 24 and 25 are placed between first foreground piece 14 and overlying foreground piece 16. Outermost foreground piece 18 is shown as lying at an angle to piece 16. This accomplished by using one standoff 26 at one location and two stacked standoffs 27 and 28 at another location. It can be seen that all of the standoffs used in FIG. 2 could be accomplished by die cutting a uniformly thick sheet of foamed plastic material with adhesive on both faces into a series of identical small rectangular-shaped pieces that are adhered to the back of each of the foreground pieces in the proper location and in the proper quantity. One example of the printed indicia for conveying this standoff location and quantity information to the user is shown in FIG. 3B, which depicts the back face 40 of foreground piece 18. Printed rectangle 42 with the number “1” printed therein indicates to the user the location of one standard rectangular standoff piece such as shown as standoff 26, FIG. 2. Second printed rectangle 44 with the number “2” therein indicates to the user to place two rectangular standoff pieces 27 and 28 on rectangle 44, thus projecting the lower portion of piece 18 farther from the background substrate 12 than the top portion. This variable height creates a variable depth in the assembled product, which can add to the visual appeal of the product. Other alternatives for conveying standoff locations and heights include separate printed instructions, or a dimensional view of the assembled product.

FIG. 4 depicts a similar but alternative means of creating a standoff that is more than two units high. Standoff 50 includes standard rectangular standoff member pieces 51 and 52 of the type described above, interconnected by a short thin rod of wood or metal or the like 53. Piece 53 could be pre-cut or left to be cut by the user with directions on its length or perhaps directions on the overall height of standoff 50. Toothpicks can be easily broken and inserted into the standard foam rectangular standoff shapes to accomplish this objective. This feature also allows the user to inject variability, as the user can alternatively design a desired standoff height to accomplish a particular desired appearance.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A set for use in creating a three-dimensional decoupage scene defined by a background scene, and a multi-piece foreground scene having depth relative to the background scene, comprising:
a background substrate carrying graphics that visually create a particular scene;
a plurality of foreground pieces each carrying on a front face graphics that are visually identical to a portion of the background scene, and each having a back face;
standoff members for attachment to the back faces of foreground pieces to separate the foreground pieces from underlying foreground pieces or the background; and
printed indicia conveying to the user an indication of one or more locations on the back face of at least one foreground piece for placement of one or more standoffs, to hold foreground pieces a particular distance off of other foreground pieces and/or the background substrate, to create depth in the overall scene.

2. The set of claim 1 wherein the background substrate defines a border area outside of the graphics that folds relative to the graphics.

3. The set of claim 2 wherein the background substrate is scored to define a fold line between the graphics and the border area.

4. The set of claim 2 wherein the border area folds to be generally perpendicular to the graphics.

5. The set of claim 4 further comprising a frame having sides with depth, in which the folded border area lies proximate the frame sides.

6. The set of claim 1 wherein the printed indicia also conveys to the user the quantity of standoff members for each location on the back face of the foreground pieces.

7. The set of claim 6 wherein the printed indicia include a number indicative of the quantity of standoff members to be placed at that location.

8. The set of claim 1 wherein the standoff members have predefined shapes and sizes.

9. The set of claim 8 wherein the printed indicia comprise borders that match the standoff shape.

10. The set of claim 9 wherein the printed indicia borders match the standoff size and shape.

11. The set of claim 10 wherein the printed indicia also conveys to the user the quantity of standoff members for each location on the back face of the foreground pieces.

12. The set of claim 1 wherein at least two foreground pieces are identical and are located one directly on top of another.

13. The set of claim 12 wherein standoff members located between two identical foreground pieces keep the pieces completely separated.

14. The set of claim 13 wherein the two identical foreground pieces are essentially parallel to one another.

15. The set of claim 1 wherein the standoff members have adhesive on their fronts and backs protected by a peel-off member.

16. The set of claim 15 wherein the standoff members are part of a sheet of material that is precut such that each member is separable from the sheet.

17. The set of claim 16 wherein the standoff members are al the same shape and size.

18. The set of claim 17 wherein the standoff members are all essentially rectangular.

19. The set of claim 1 wherein at least one standoff member comprises two separate adhesive portions joined by an elongated member, to increase the thickness of the standoff.

20. A three-dimensional decoupage scene defined by a background scene and a foreground scene having depth relative to the background scene, comprising:
a background substrate carrying graphics that visually create a particular background scene;
a plurality of foreground pieces each carrying on a front face graphics that are visually identical to a portion of the foreground scene, and each having a back face;
a plurality of foreground piece standoffs; and
printed indicia carried on the back face of each foreground piece conveying to the user an indication of one or more locations on the back face for placement of one or more standoffs;
wherein the standoffs are located between the back face of each foreground piece and an underlying foreground piece or the background substrate, to hold foreground pieces a particular distance off of the underlying piece or the background substrate, to create depth in the overall scene comprising the background scene and the foreground scene made up from the plurality of foreground pieces.
